(19) United States
(12) Patent Application Publication
(10) Pub. No.: US 2005/0254381 A1
(43) Pub. Date: Nov. 17, 2005

(54) System and method for detecting faulty media in a media player

(76) Inventor: Joseph Desormeaux JR., Saline, MI (US)

Correspondence Address: FORD GLOBAL TECHNOLOGIES, LLC., SUITE 600 - PARKLANE TOWERS EAST, ONE PARKLANE BLVD., DEARBORN, MI, 48126, US

(21) Appl. No.: 10/833,700

(22) Filed: Apr. 28, 2004

(51) Int. Cl. G11B 7/09

(52) U.S. Cl. 369/53.15; 369/53.12; 369/53.1

(57) ABSTRACT

The invention disclosed is a system and method for detecting faulty media in a media player. The system comprises a sensor or group of sensors to scan the media disc while it is loaded into the media player and while it is being played. If a physical anomaly of the media disc is detected, the media player ejects the media disc. The method includes the steps of scanning the media disc while it is being loaded into the media player. The method further includes the step of scanning the media disc while it is being played. If the scanning detects a physical anomaly of the media disc, the media disc is ejected. This system and method protects the media player from being jammed or damaged by faulty discs that a user attempts to insert and play, thus reducing the expense associated with repairing damaged media players.

### TECHNICAL FIELD OF THE INVENTION

The invention described herein relates in general to a system and method of detecting faulty media inserted into a media player.

### BACKGROUND OF THE INVENTION

Media players, e.g., compact disc (CD) players and DVD players, have been available for a number of years. These players, and their associated computer counterparts (CD-ROM drive, CD-R drive, CD-RW drive, DVD-ROM drive, etc.), are present in many forms. For example, personal CD players with headphones can be found at most gyms, almost all personal computers have either a CD-RW or DVD drive, and many people have either a CD or DVD player, or both, present in their home entertainment system.

With the advent of the writable and rewritable CD and DVD drives, more and more individuals are making copies of their CD's and DVD's for their own personal use and for the sake of convenience, e.g., having two copies of one's favorite CD, one in a car and one in a home entertainment system. Associated with this personal copying, many people are creating labels to attach to the media disc in order to identify its contents. These labels are usually attached to the discs by some form of adhesive. Misapplied labels, or those that become partially detached from the discs, can cause damage to the media player, e.g., jamming the player. Additionally, damaged discs, for example those that are cracked or split, can damage the media player and its sensitive electronics when they are rotated while being played. Current media players have no mechanism to detect such faulty media before it has had the ability to jam or cause damage to the player.

The problems described above are magnified for front-loading media players, e.g., those in vehicles, and especially for multi-disc front-loading media players. This type of player is generally loaded and unloaded by passing a disc through a narrow opening in the front of the media player approximately the same size of disc. Because of the small size of the opening, these players become jammed more easily.

Additionally, these players and their inserted media are usually subjected to a wider range of environmental conditions than those used in the home. A media player in a vehicle can be subjected to temperatures below freezing in the winter, temperatures above 120° Fahrenheit in the summer, and a wide range of humidity conditions. Furthermore, the media players is expected to operate in all conditions and even during drastic change of conditions, e.g., below freezing in the winter when a vehicle is first started and continuing even after the vehicle's interior has met or exceeded room temperature. These harsh conditions and the rapid change in conditions tend to damage media discs that remain inserted in the player, either by cracking the media disc itself or loosening the label adhered to the media disc. This faulty media can damage the player if the player allows it to rotate and play. A media player that can detect faulty or damaged media before it can damage the player would be desirable.

### SUMMARY OF THE INVENTION

This invention relates to a system and method for detecting faulty media in a media player.

In one aspect, the invention is directed to a system for detecting faulty media in a media player. This system comprises a media player that is capable of receiving a media disc. The system further comprises at least one sensor associated with the media player that is capable of detecting a physical anomaly of the media disc when it is received by the media player. The system is also comprised of an ejection mechanism coupled with the at least one sensor, whereby the ejection mechanism ejects the media disc when the at least one sensor detects the physical anomaly.

In another aspect, this invention is related to a system for detecting faulty media in a media player. This system comprises a media player and at least one sensor associated with the media player, the at least one sensor being capable of detecting a physical anomaly of a media disc when said media disc is played by said media player. The system further comprises an ejection mechanism coupled with the at least one sensor, whereby said ejection mechanism ejects the media disc when the at least one sensor detects the physical anomaly.

In another aspect, this invention is related to a method for detecting faulty media in a media player. The method includes the step of loading a media disc into a media player. The method further includes the steps of scanning the media disc during loading, the scanning being capable of detecting a physical anomaly of the media disc, and ejecting the media disc when the physical anomaly is detected.

### BRIEF DESCRIPTION OF THE DRAWINGS

These and other features and advantages of the present invention will be apparent to those of ordinary skill in the art in view of the detailed description of the preferred embodiment which is made with reference to the drawings, a brief description of which is provided below.

FIG. 1 is an illustration of a front-loading media player with a system for detecting faulty media according to a first embodiment of the invention.

FIG. 2 is a cross sectional view taken along the line A-A′ of the front-loading media player shown in FIG. 1.

FIG. 3 is a cross sectional view taken along the line B-B′ of the front-loading media player shown in FIG. 1.

FIG. 4 is a flowchart describing a method for detecting faulty media in a media player according to a third embodiment of the invention.

### DETAILED DESCRIPTION OF THE PREFERRED EMBODIMENTS

This invention is a system and method for detecting faulty media in a media player. A media disc can be faulty or damaged in various ways. One example of a faulty media disc is one that has a misapplied label, e.g., the label extends off of the disc, the label is peeling and has become separated from the disc, or the label is wrinkled or bubbled on the disc. Another example of a faulty media disc is when the disc itself has been compromised in some manner, e.g., the disc has a crack, the disc has warped, or the disc has become misshaped. Any one physical anomaly of a media disc, like those listed above, can damage a media player if that player is allowed to play the faulty disc.

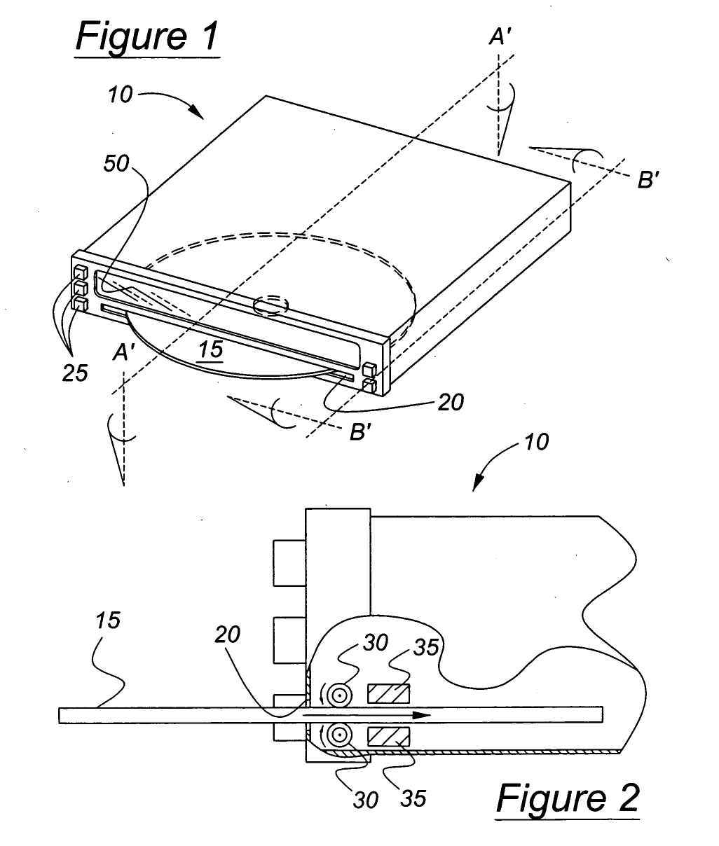

FIG. 1 is an illustration of a front-loading media player 10 with a system for detecting faulty media according to a preferred embodiment of the invention. Media disc 15 is shown partially inserted into the media player 10 through opening 20. Various buttons 25 are shown on the front of the media player 10. These buttons 25 perform the normal tasks associated with a media player 10, e.g., play, stop, fast-forward, rewind, pause.

The media disc is received inside the media player through opening 20. This is preferably accomplished by a roller mechanism 30, as shown in FIG. 2. The media disc could be received through another type of guiding mechanism, however the roller mechanism 30 is preferred because it is least likely to damage the media disc and its label, if any, and can further be used to eject the media disc. The directional arrows shown in FIG. 2 describe the movement of the roller mechanism 30 and media disc 15 during the loading process. The roller mechanism 30 would move in the opposite direction during the ejection process.

During the loading process, at least one sensor 35 scans the media disc 15 for any physical anomalies. Various types of sensors, well known in the art, could be utilized to detect physical anomalies. If the sensor(s) 35 detects a physical anomaly of the media disc 15 during loading, the media player 10 will eject the media disc 15 and, preferably, display an error message on a display device 50, shown in FIG. 1, of the media player 10. This error message could be as simple as outputting the word “ERROR” or as complex as stating what physical anomaly was detected, for example “ERROR: Loose Label.” Instead of, or in addition to, displaying an error message on the display device 50 when a physical anomaly is detected, the media player 10 could transmit an audio signal to the audio output section of the media player 10 to indicate that there was an error. For example, the error message could be a voice recording that verbally states “ERROR” or “ERROR: Loose Label” over the speakers connected to the media player 10. Preferably, both a visual and audio error message is transmitted when a physical anomaly of is detected.

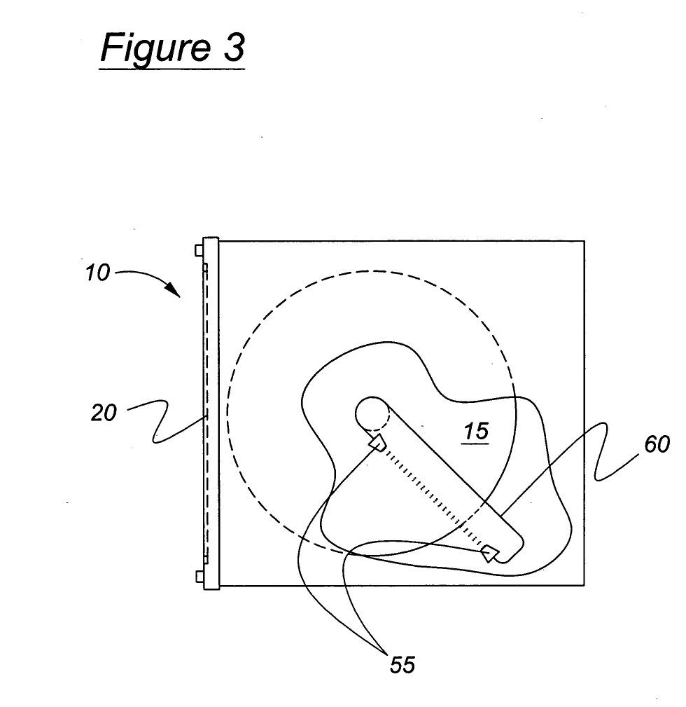

In addition to the sensor(s) 35 utilized to detect physical anomalies of the media disc 15 during loading, a preferred embodiment of the invention utilizes a second sensor or set of sensors 55, as shown in FIG. 3. The second sensor(s) 55 scans the media disc 15 for any physical anomalies while it is being played by the media player 10.

The media disc 15 is rotated rapidly during playing, and a physical anomaly that went undetected during the loading process may be detected by the second sensor(s) 55 when the media disc 15 is played (for example an unbalanced media disc 15 is difficult to detect without being rotated). Additionally, scanning the media disc 15 while it is played is necessary if the media disc 15 becomes damaged while after it has been loaded into the media player 10. The practice of leaving numerous media discs 15 in a media player 10 for extended periods of time is common, especially for multiple-disc media players 10. This practice results in the loaded media discs 15 being subjected to the same harsh conditions described in the Background, which increase the risk of damage to the media discs 15 inside the media player 10. Scanning for physical anomalies only during the loading process would not detect the damage to a media disc 15 already loaded into the media player 15. If a physical anomaly is detected by the second sensor(s) 55, the media disc 15 would be ejected by the media player 10.

The second sensor(s) 55 is preferably mounted on the clamp arm 60 of the media player 10. Mounting the second sensor(s) 55 on the clamp arm 60 allows the system to scan the whole media disc 15 when it is rotated, while only scanning half of the surface distance, i.e., the radius of the media disc 15. Scanning a smaller area is beneficial because a less complex sensor and processor is necessary.

Another embodiment of the invention utilizes only the second sensor(s) 55 to scan during both the loading and playing process. During the loading process, the media player 10 rotates the media disc 15 slowly, which allows the second sensor(s) 55 to scan the entire media disc 15 before it is played. If a physical anomaly is detected, the media player 10 ejects the media disc 15. If no physical anomaly is detected, the media player 10 accepts the media disc 15 for playing. The second sensor(s) 55 also scans the media disc 15 for any physical anomalies while it is being played by the media player 10, and ejects the media disc 15 if a physical anomaly is detected.

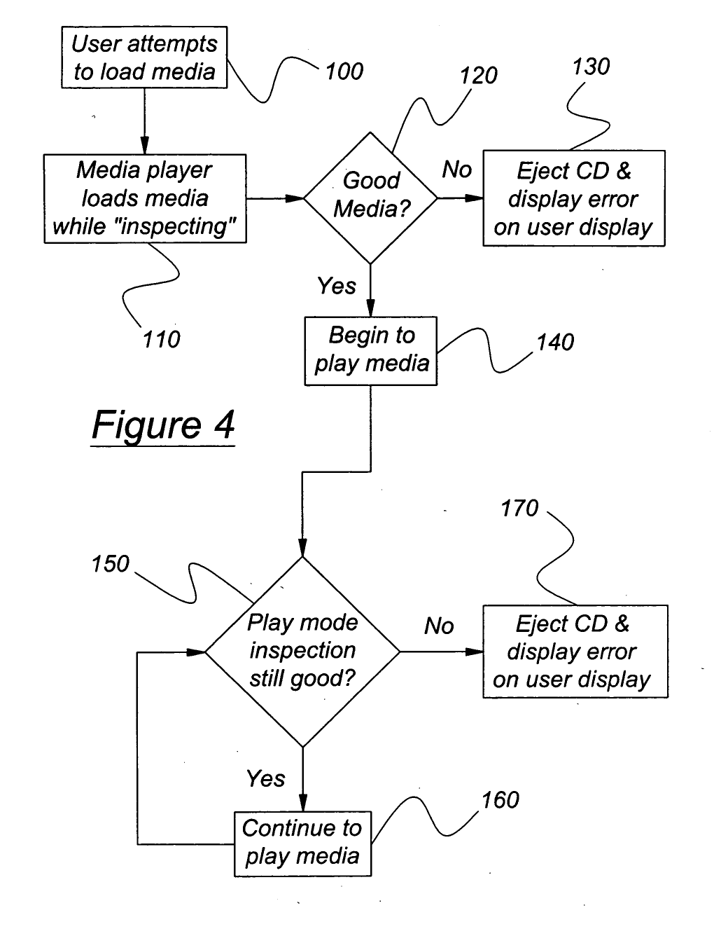

A flow chart describing the preferred method of detecting faulty media in a media player 10 is shown in FIG. 4. At step 100, a user attempts to load a media disc 15 into the media player 10. At step 110, the media disc 15 is scanned to detect any physical anomaly of the media disc 15. At step 120, the system determines if the media disc 15 has a physical anomaly. If the media disc 15 has a physical anomaly, the media player 10 ejects the media disc 15 at step 130. If no physical anomaly is detected at step 120, the media disc 15 is accepted for playing by the media player 10 at step 140.

The media player 10 begins playing the media disc 15 at step 140 after the media disc 15 has been accepted. Alternatively, the media player 10 could remain idle until being instructed by a user to begin playing the media disc. At step 150 the system scans the media disc 15 while it is played. If a physical anomaly is not detected, the media player continues to play the media disc 15 at step 160 and then returns to step 150 to resume scanning. If a physical anomaly is detected at step 160, the media player 10 ejects the media disc 15 at step 170. The method can be modified to include further steps, for example the step of generating an error message as described above.

Persons of ordinary skill in the art will readily appreciate that a system and method for detecting faulty media in a media player has been provided. The foregoing description has been presented for the purposes of illustration and description. It is not intended to be exhaustive or to limit the invention to the precise form disclosed. Many modifications and variations are possible in light of the above teachings. It is intended that the scope of the invention be limited not by this detailed description, but rather by the claims appended hereto.

1. A system for detecting faulty media in a media player comprising:
a media player, said media player being capable of receiving a media disc,
at least one sensor associated with said media player, said at least one sensor being capable of detecting a physical anomaly of said media disc when said media disc is received by said media player, and
an ejection mechanism coupled with said at least one sensor, whereby said ejection mechanism ejects said media disc when said at least one sensor detects said physical anomaly.

2. The system of claim 1, wherein said physical anomaly comprises a crack in said media disc.

3. The system of claim 1, wherein said physical anomaly comprises a misapplied label.

4. The system of claim 1, wherein said physical anomaly comprises said media disc being of a thickness greater than a thickness standard.

5. The system of claim 4, wherein said thickness standard is approximately 1.5 millimeters.

6. The system of claim 1, further comprising an output section of said media player, said output section being capable of outputting an error message when said at least one sensor detects said physical anomaly.

7. The system of claim 6, wherein said error message comprises a visual message.

8. The system of claim 6, wherein said error message comprises an audio message.

9. The system of claim 1, further comprising at least one additional sensor, said at least one additional sensor being capable of detecting said physical anomaly of said media disc when said media disc is played by said media player, said at least one additional sensor being coupled with said ejection mechanism, whereby said ejection mechanism ejects said media disc when said at least one additional sensor detects said physical anomaly.

10. The system of claim 9, wherein said physical anomaly comprises a crack in said media disc.

11. The system of claim 9, wherein said physical anomaly comprises a misapplied label.

12. The system of claim 9, further comprising an output section of said media player, said output section being capable of outputting an error message when said at least one additional sensor detects said physical anomaly.

13. The system of claim 12, wherein said error message comprises a visual message.

14. The system of claim 12, wherein said error message comprises an audio message.

15. The system of claim 1, wherein said at least one sensor is further capable of detecting said physical anomaly of said media disc when said media disc is played by said media player.

16. The system of claim 15, wherein said physical anomaly comprises a crack in said media disc.

17. The system of claim 15, wherein said physical anomaly comprises a misapplied label.

18. The system of claim 15, further comprising an output section of said media player, said output section being capable of outputting an error message when said at least one sensor detects said physical anomaly.

19. The system of claim 18, wherein said error message comprises a visual message.

20. The system of claim 18, wherein said error message comprises an audio message.

21. A system for detecting faulty media in a media player comprising:
a media player,
at least one sensor associated with said media player, said at least one sensor being capable of detecting a physical anomaly of a media disc when said media disc is played by said media player, and
an ejection mechanism coupled with said at least one sensor, whereby said ejection mechanism ejects said media disc when said at least one sensor detects said physical anomaly.

22. The system of claim 21, wherein said physical anomaly comprises a crack in said media disc.

23. The system of claim 21, wherein said physical anomaly comprises a misapplied label.

24. The system of claim 21, further comprising an output section of said media player, said output section being capable of outputting an error message when said at least one sensor detects said physical anomaly.

25. The system of claim 24, wherein said error message comprises a visual message.

26. The system of claim 24, wherein said error message comprises an audio message.

27. A method for detecting faulty media in a media player comprising:
loading a media disc into a media player,
scanning said media disc during said loading, said
scanning being capable of detecting a physical anomaly of said media disc, and
ejecting said media disc when said physical anomaly is detected.

28. The method of claim 27, wherein said physical anomaly comprises a crack in said media disc.

29. The method of claim 27, wherein said physical anomaly comprises a misapplied label.

30. The method of claim 27, wherein said physical anomaly comprises said media disc being of a thickness greater than a thickness standard.

31. The method of claim 30, wherein said thickness standard is approximately 1.5 millimeters.

32. The method of claim 27, further comprising the step of outputting an error message when said physical anomaly is detected.

33. The method of claim 32, wherein said error message comprises a visual message.

34. The method of claim 32, wherein said error message comprises an audio message.

35. The method of claim 21, further comprising the steps of playing said media disc by said media player and scanning said media disc while said media disc is played by said media player, said scanning being capable of detecting said physical anomaly.

36. The method of claim 35, wherein said physical anomaly comprises a crack in said media disc.

37. The method of claim 35, wherein said physical anomaly comprises a misapplied label.

38. The method of claim 35, further comprising the step of outputting an error message when said physical anomaly is detected.

39. The method of claim 38, wherein said error message comprises a visual message.

40. The method of claim 38, wherein said error message comprises an audio message.
